(19) United States
(12) Patent Application Publication
(10) Pub. No.: US 2023/0028231 A1
(43) Pub. Date: Jan. 26, 2023

(54) COPOLYMER OF ETHYLENE AND A 1,3-DIENE

(71) Applicant: COMPAGNIE GENERALE DES ETABLISSEMENTS MICHELIN, Clermont-Ferrand (FR)

(72) Inventors: Leyla Pehlivan, Clermont-Ferrand (FR); Florent Vaultier, Clermont-Ferrand (FR); Stéphanie Pinel, Clermont-Ferrand (FR)

(21) Appl. No.: 17/784,782

(22) PCT Filed: Dec. 14, 2020
(86) PCT No.: PCT/FR2020/052429

§ 371 Date: Jun. 13, 2022

(30) Foreign Application Priority Data
Dec. 18, 2019 (FR) FR1914707

(51) Int. Cl. C08F 210/02

(52) U.S. Cl. CPC C08F 210/02

(57) ABSTRACT

A copolymer of ethylene and a 1,3-diene, containing more than 50 mol % of ethylene units and containing 1,2-cyclohexanediyl units is provided. The 1,3-diene is 1,3-butadiene or a mixture of 1,3-dienes containing 1,3-butadiene, and the copolymer consists of a main chain and one or more side chains.

### CROSS-REFERENCE TO RELATED APPLICATIONS

This U.S. national phase patent application claims priority to and the benefit of International Patent Application No. PCT/FR2020/052429, filed on Dec. 14, 2020, which claims priority to and the benefit of French patent application no. FR1914707, filed Dec. 18, 2019, the contents of which are incorporated herein by reference in their entirety.

### BACKGROUND

### 1. Technical Field

The field of the present invention is that of highly saturated diene copolymers containing ethylene and 1,3-butadiene units.

### 2. Related Art

The most widely used diene elastomers in the manufacture of tires are polybutadienes, polyisoprenes, in particular natural rubber, and copolymers of 1,3-butadiene and of styrene. The point common to these elastomers is the high molar proportion of diene units in the elastomer, generally much greater than 50%, which can render them sensitive to oxidation, in particular under the action of ozone.

The applicant has described copolymers which, on the contrary, are relatively poor in diene units, in particular for the purpose of reducing their sensitivity to oxidation phenomena. Another advantage of these copolymers is the use of ethylene which is a common and commercially available monomer, which is accessible via the fossil or biological route. These copolymers are, for example, described in document WO 2007054223. These are copolymers of 1,3-butadiene and of ethylene containing more than 50 mol % of ethylene unit. They are synthesized in the presence of a catalytic system comprising a neodymium metallocene. These ethylene-rich copolymers of 1,3-butadiene and of ethylene are crystalline and experience an increase in their crystallinity with the content of ethylene. The presence of crystalline parts gives the copolymer a high stiffness which may prove to be too high for certain applications.

To reduce the crystallinity of the copolymers of ethylene and of 1,3-butadiene, the applicant has developed a new catalytic system, as is described in document WO 2007054224, and has prepared new copolymers of ethylene and of 1,3-butadiene with reduced crystallinity, or even with the crystallinity eliminated, despite their high ethylene content. These copolymers have the particularity of containing 6-membered saturated hydrocarbon-based cyclic moieties. It has been found that these copolymers of ethylene and of 1,3-butadiene tend to flow under their own weight. This cold flow is not controlled and can pose difficulties in the use of these copolymers, in particular during their storage in the form of balls or in storage boxes.

### SUMMARY

An objective of the invention is to overcome the drawbacks mentioned.

This objective is achieved by the invention which proposes a branched copolymer which contains ethylene and 1,3-butadiene units, which copolymer contains more than 50 mol % of ethylene units and contains 1,2-cyclohexanediyl moieties.

Thus, a subject of the invention is a copolymer of ethylene and of a 1,3-diene containing more than 50 mol % of ethylene units and containing 1,2-cyclohexanediyl moieties, the 1,3-diene being 1,3-butadiene or a mixture of 1,3-dienes containing 1,3-butadiene, which copolymer consists of a main chain and of one or more side chains.

The invention also relates to a rubber composition which comprises a copolymer in accordance with the invention.

The invention also relates to a tire which comprises a rubber composition in accordance with the invention.

### DETAILED DESCRIPTION OF EXAMPLE EMBODIMENTS

Any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b). The abbreviation “phr” means parts by weight per hundred parts by weight of elastomer (of the total of the elastomers if several elastomers are present).

The expression “based on” used to define the constituents of a catalytic system or of a composition is understood to mean the mixture of these constituents, or the product of the reaction of a portion or of all of these constituents with one another.

Unless otherwise indicated, the contents of the units resulting from the insertion of a monomer into a copolymer are expressed as molar percentage relative to all of the units and moieties which result from the insertion of the monomers into the polymer.

The compounds mentioned in the description can be of fossil origin or be biobased. In the latter case, they may be partially or completely derived from biomass or be obtained from renewable starting materials derived from biomass. This concerns in particular elastomers, plasticizers, fillers, etc.

The copolymer in accordance with the invention has the essential characteristic of being a copolymer of ethylene and of a 1,3-diene, the 1,3-diene being 1,3-butadiene or a mixture of 1,3-dienes containing 1,3-butadiene, which implies that the monomer units of the copolymer are those resulting from the copolymerization of ethylene and of 1,3-butadiene or from the copolymerization of ethylene and of a mixture of 1,3-dienes containing 1,3-butadiene.

The copolymer also has the characteristic of comprising more than 50 mol % of ethylene units. In known manner, the term “ethylene unit” is understood to mean a unit which has the moiety —(CH₂—CH₂)—. Preferably, the copolymer contains more than 60 mol % of ethylene units.

According to one particular embodiment of the invention, the copolymer contains less than 90 mol % of ethylene units.

According to one particular embodiment of the invention, the copolymer contains at most 85 mol % of ethylene units.

The copolymer also has the essential characteristic of containing 1,2-cyclohexanediyl moieties. A 1,2-cyclohexanediyl moiety corresponds to formula (I). The presence of these cyclic moieties in the copolymer results from a very specific insertion of ethylene and of 1,3-butadiene during their copolymerization, as is described for example in document WO 2007054224. Preferably, the copolymer contains at most 15 mol % of 1,2-cyclohexanediyl moieties. The content of units of 1,2-cyclohexanediyl moieties in the copolymer varies according to the respective contents of ethylene and of 1,3-butadiene.

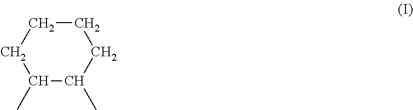

According to one particularly preferentially embodiment, the 1,3-diene is 1,3-butadiene, in which case the copolymer is a copolymer of ethylene and of 1,3-butadiene.

The copolymer in accordance with the invention also has another essential feature, namely that of being branched. In other words, it consists of a main chain and of one or more side chains. Since the copolymer is a copolymer of ethylene and of a 1,3-diene, the monomer units of the main chain and of the side chains are those resulting from the copolymerization of ethylene and of 1,3-diene. When the 1,3-diene is 1,3-butadiene according to one particularly preferential embodiment, the monomer units of the main chain and of the side chains are those resulting from the copolymerization of ethylene and of 1,3-butadiene.

Preferably, at least one side chain is attached to the main chain by a covalent bond between a side chain carbon atom and a main chain carbon atom. More preferentially, the carbon atoms involved in the covalent bond to ensure attachment of a side chain to the main chain are carbon atoms resulting from the insertion of ethylene or of 1,3-diene into the copolymer by copolymerization.

Preferably, the copolymer has a degree of crystallinity of less than 20%. More preferentially, the copolymer has a degree of crystallinity of less than 10%. Even more preferentially, the copolymer has a degree of crystallinity of less than 5%. Preferably, the copolymer is a statistical copolymer. Preferably, the copolymer is an elastomer. The copolymer, in particular when it is an elastomer, is intended to be used in a rubber composition, in particular for a tire.

The copolymer in accordance with the invention is typically prepared by copolymerization of ethylene and of 1,3-diene in the presence of a catalytic system such as that described in document WO 2007054224.

The catalytic system comprises a metallocene of formula (I) and an organomagnesium

P(Cp¹Cp²)Nd(BH₄)_{(1+y)}-L_{y}-Nₓ (I)

Cp¹ and Cp², which may be identical or different, being selected from the group consisting of substituted fluorenyl groups and the unsubstituted fluorenyl group of formula C₁₃H₈,
P being a group bridging the two Cp¹ and Cp² groups and representing a ZR³R⁴ group, Z representing a silicon or carbon atom, R³ and R⁴, which may be identical or different, each representing an alkyl group comprising from 1 to 20 carbon atoms, preferably a methyl,
y, which is an integer, being equal to or greater than 0,
x, which is or is not an integer, being equal to or greater than 0,
L representing an alkali metal selected from the group consisting of lithium, sodium and potassium,
N representing a molecule of an ether, preferably diethyl ether or tetrahydrofuran,

In formula (I), the neodymium atom is connected to a ligand molecule consisting of the two Cp¹ and Cp² groups which are connected together by the bridge P. Preferably, the symbol P, denoted by the term bridge, corresponds to the formula ZR¹R², Z representing a silicon atom, R¹ and R², which may be identical or different, representing an alkyl group comprising from 1 to 20 carbon atoms. More preferentially, the bridge P is of formula SiR¹R², R¹ and R² being identical and as defined above. More preferentially still, P corresponds to the formula SiMe₂.

Mention may be made, as substituted fluorenyl groups, of those substituted by alkyl radicals having from 1 to 6 carbon atoms or by aryl radicals having from 6 to 12 carbon atoms. The choice of the radicals is also guided by the accessibility to the corresponding molecules, which are the substituted fluorenes, because the latter are commercially available or can be easily synthesized.

Mention may more particularly be made, as substituted fluorenyl groups, of the 2,7-di(tert-butyl)fluorenyl and 3,6-di(tert-butyl)fluorenyl groups. The 2, 3, 6 and 7 positions respectively denote the position of the carbon atoms of the rings as represented in the scheme below, the 9 position corresponding to the carbon atom to which the bridge P is attached.

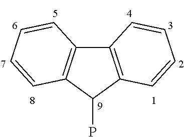

Preferably Cp¹ and CP² are identical. Advantageously, in the formula (I) Cp¹ and CP² each represent the fluorenyl group. The fluorenyl group is of formula C₁₃H₈. Preferably, the metallocene is of formula (Ia), (Ib), (Ic), (Id) or (Ie), in which the symbol Flu presents the fluorenyl group of formula C₁₃H₈.

[{Me₂SiFlu₂Nd(μ-BH₄)₂Li(THF)}₂] (Ia)

[Me₂SiFlu₂Nd(μ-BH₄)₂Li(THF)] (Ib)

[Me₂SiFlu₂Nd(μ-BH₄)(THF)] (Ic)

[{Me₂SiFlu₂Nd(μ-BH₄)(THF)}₂] (Id)

[Me₂SiFlu₂Nd(μ-BH₄)] (Ie)

The organomagnesium compound used in the catalytic system as a cocatalyst is a compound which has at least one C—Mg bond. Mention may be made, as organomagnesium compounds, of diorganomagnesium compounds, in particular dialkylmagnesium compounds, and of organomagnesium halides, in particular alkylmagnesium halides. A diorganomagnesium compound is typically of formula MgR³R⁴ in which R³ and R⁴, which may be identical or different, represent a carbon group. Carbon group is understood to mean a group which contains one or more carbon atoms. Preferably, R³ and R⁴ contain from 2 to 10 carbon atoms. More preferentially, R³ and R⁴ each represent an alkyl. The organomagnesium compound is advantageously a dialkylmagnesium compound, better still butylethylmagnesium or butyloctylmagnesium, even better still butyloctylmagnesium.

The catalytic system can be prepared conventionally by a process analogous to that described in Patent Application WO 2007054224. For example, the organomagnesium compound and the metallocene are reacted in a hydrocarbon-based solvent typically at a temperature ranging from 20° C. to 80° C. for a period of time of between 5 and 60 minutes. The catalytic system is generally prepared in an aliphatic hydrocarbon-based solvent, such as methylcyclohexane, or an aromatic hydrocarbon-based solvent, such as toluene.

The metallocene used for preparing the catalytic system can be in the form of a crystalline or non-crystalline powder, or else in the form of single crystals. The metallocene can be provided in a monomer or dimer form, these forms depending on the method of preparation of the metallocene, as for example is described in application WO 2007054224. The metallocene can be prepared conventionally by a process analogous to that described in Patent Application WO 2007054224, in particular by reaction, under inert and anhydrous conditions, of the salt of an alkali metal of the ligand with a rare earth metal borohydride in a suitable solvent, such as an ether, for example diethyl ether or tetrahydrofuran, or any other solvent known to those skilled in the art. After reaction, the metallocene is separated from the reaction by-products by techniques known to those skilled in the art, such as filtration or precipitation from a second solvent. In the end, the metallocene is dried and isolated in the solid form.

Those skilled in the art adjust the molar ratio of the organomagnesium to the Nd metal constituting the metallocene according to the molar mass of the desired copolymer. The molar ratio may reach the value of 100, knowing that a molar ratio of less than 10 is more favourable for obtaining polymers with high molar masses.

Like any synthesis carried out in the presence of an organometallic compound, the synthesis of the metallocene and that of the catalytic system take place under anhydrous conditions under an inert atmosphere. Typically, the reactions are carried out starting from anhydrous solvents and compounds under anhydrous nitrogen or argon.

The catalytic system is generally introduced into the reactor containing the polymerization solvent and the monomers.

The catalytic system can be prepared conventionally by a process analogous to that described in Patent Application WO 2007054224. For example, the organomagnesium compound and the metallocene are reacted in a hydrocarbon-based solvent typically at a temperature ranging from 20° C. to 80° C. for a period of time of between 5 and 60 minutes. The catalytic system is generally prepared in an aliphatic hydrocarbon-based solvent, such as methylcyclohexane, or an aromatic hydrocarbon-based solvent, such as toluene. Generally, after its synthesis, the catalytic system is used in this form in the process for the synthesis of the copolymer in accordance with the invention.

Alternatively, the catalytic system can be prepared by a process analogous to that described in Patent Application WO 2017093654 A1 or in Patent Application WO 2018020122 A1. According to this alternative, the catalytic system further contains a preformation monomer selected from a conjugated diene, ethylene or a mixture of ethylene and a conjugated diene, in which case the catalytic system is based at least on the metallocene, the organomagnesium compound and the preformation monomer. For example, the organomagnesium compound and the metallocene are reacted in a hydrocarbon-based solvent typically at a temperature of from 20° C. to 80° C. for 10 to 20 minutes in order to obtain a first reaction product, then the preformation monomer, selected from a conjugated diene, ethylene or a mixture of ethylene and of a conjugated diene, is reacted with this first reaction product at a temperature ranging from 40° C. to 90° C. for 1 h to 12 h. The catalytic system thus obtained can be used immediately in the process in accordance with the invention or be stored under an inert atmosphere before it is used in the process in accordance with the invention.

Those skilled in the art also adjust the polymerization conditions and the concentrations of each of the reactants (constituents of the catalytic system, monomers) according to the equipment (devices, reactors) used to carry out the polymerization and the various chemical reactions. As is known to those skilled in the art, the copolymerization and the handling of the monomers, of the catalytic system and of the polymerization solvent(s) take place under anhydrous conditions and under an inert atmosphere. The polymerization solvents are typically aliphatic or aromatic hydrocarbon-based solvents. The polymerization solvent is preferably aliphatic, advantageously methylcyclohexane.

To obtain the copolymers in accordance with the invention, the polymerization temperature is at least 100° C. Conversion rates are high, for example over 90%. Preferably, the copolymerization is carried out at constant ethylene pressure.

The polymerization can be stopped by cooling the polymerization medium or by adding an alcohol, preferentially an alcohol containing 1 to 3 carbon atoms, for example ethanol. The polymer can be recovered according to conventional techniques known to those skilled in the art, such as, for example, by precipitation, by evaporation of the solvent under reduced pressure or by steam stripping.

The copolymer in accordance with the invention, in particular when it an elastomer, is advantageously used in a rubber composition, in particular in a rubber composition for a tire.

The abovementioned characteristics of the present invention, and also others, will be better understood on reading the following description of several exemplary embodiments of the invention, given by way of illustration and without limitation.

### Implementation Examples of the Invention

Polymer Characterization Methods:

Nuclear Magnetic Resonance (NMR):

The copolymers of ethylene and of 1,3-butadiene are characterized by ¹H and ¹³C NMR spectrometry. The NMR spectra are recorded on a Bruker Avance III HD 500 MHz spectrometer equipped with a BBFO z-grad 5 mm “broad band” cryoprobe. The quantitative ¹H NMR experiment uses a 30° single pulse sequence and a repetition delay of 5 seconds between each acquisition. 64 to 256 accumulations are carried out. The quantitative ¹³C NMR experiment uses a 300 single pulse sequence with a proton decoupling and a repetition delay of 10 seconds between each acquisition. 1024 to 10240 accumulations are carried out. ¹H/¹³C two-dimensional experiments are used for the purpose of determining the structure of the polymers. The determination of the microstructure of the copolymers is defined in the literature, according to the article by Llauro et al., Macromolecules 2001, 34, 6304-6311.

Inherent Viscosity:

The inherent viscosity at 25° C. of a 0.1 g/dl solution of polymer in toluene is measured starting from a solution of dry polymer.

The inherent viscosity is determined by the measurement of the flow time t of the polymer solution and of the flow time to of the toluene in a capillary tube. The flow time of the toluene and the flow time of the 0.1 g/dl polymer solution are measured in an Ubbelohde tube (diameter of the capillary 0.46 mm, capacity 18 to 22 ml) placed in a bath thermostatically controlled at 25±0.1° C.

The inherent viscosity is obtained by the following relationship:

ηᵢₙₕ=[ln(t/t₀)]/C

where:
C: concentration of the toluene solution of polymer in g/dl;
t: flow time of the solution of polymer in toluene in seconds; to: toluene flow time in seconds;
ηᵢₙₕ: inherent viscosity expressed in dl/g.

Cold Flow:

The cold flow CF 100(1+6) results from the following measurement method:

It is a matter of measuring the weight of rubber extruded through a calibrated die over a given time (6 hours), under fixed conditions (at 100° C.). The die has a diameter of 6.35 mm for a thickness of 0.5 mm.

The cold flow apparatus is a cylindrical cup pierced at the base. Approximately 40 g±4 g of rubber, preprepared in the form of a pellet (thickness of 2 cm and diameter of 52 mm), are placed in this device. A calibrated piston weighing 1 kg (±5 g) is positioned on the rubber pellet. The assembly is subsequently placed in an oven thermally stabilized at 100° C.±0.5° C.

During the first hour in the oven, the measurement conditions are not stabilized. After one hour, the product which has extruded is thus cut off and discarded.

The measurement subsequently lasts 6 hours±5 min, during which the product is left in the oven. At the end of the 6 hours, the sample of extruded product must be recovered by cutting it flush with the surface of the bottom. The result of the test is the weight of rubber weighed in grams.

Mooney Viscosity:

The Mooney viscosity ML(1+4) at 100° C. is measured according to Standard ASTM: D-1646.

An oscillating consistometer is used as described in Standard ASTM D-1646. The Mooney plasticity measurement is carried out according to the following principle: the composition in the green state (i.e., before curing) is moulded in a cylindrical chamber heated to 100° C. After preheating for one minute, the rotor rotates within the test specimen at 2 revolutions/minute and the working torque for maintaining this movement is measured after rotating for 4 minutes. The Mooney plasticity (ML 1+4) is expressed in “Mooney unit” (MU, with 1 MU=0.83 N·m).

Degree of Crystallinity of the Polymers:

Standard ISO 11357-3:2011 is used to determine the temperature and enthalpy of fusion and of crystallization of the polymers used by differential scanning calorimetry (DSC). The reference enthalpy of polyethylene is 277.1 J/g (according to Polymer Handbook, 4th Edition, J. Brandrup, E. H. Immergut and E. A. Grulke, 1999).

Synthesis of Copolymers of Ethylene and of 1,3-butadiene:

Butyloctylmagnesium (BOMAG) in the contents indicated in Table 1 is added to a 70 l reactor containing methylcyclohexane (64 l), and ethylene and 1,3-butadiene in the molar proportions 81/29, and then the catalytic system is added to said reactor in the contents indicated in Table 1. At that time, the reaction temperature is adjusted to a temperature indicated in Table 1 and the polymerization reaction starts. The polymerization reaction takes place at a constant pressure which is likewise indicated in Table 1. The reactor is fed throughout the polymerization with ethylene and 1,3-butadiene in the molar proportions 81/29 The polymerization reaction is halted by cooling, degassing of the reactor and addition of ethanol. An antioxidant is added to the polymer solution. The copolymer is recovered after steam stripping and drying to constant mass. The weighed mass makes it possible to determine the mean catalytic activity of the catalytic system, expressed in kilograms of polymer synthesized per mole of neodymium metal and per hour (kg/mol·h⁻).

The catalytic system is a preformed catalytic system. It is prepared in methylcyclohexane from a metallocene, [Me₂Si(Flu)₂Nd(μ-BH₄)₂Li(THF)] at 0.0065 mol/l, a cocatalyst, butyloctylmagnesium (BOMAG), the BOMAG/Nd molar ratio of which=2.2, and a preformation monomer, 1,3-butadiene, the 1,3-butadiene/Nd molar ratio of which=90. The medium is heated at 80° C. over a period of 5 h. It is prepared according to a preparation method in accordance with paragraph 11.1 of Patent Application WO 2017093654 A1.

Tests 1 to 9 differ from one another by the amount of cocatalyst used, by the polymerization pressure and by the polymerization temperature. The polymerization temperature being 105° C., tests 1 and 2 are examples in accordance with the invention, whereas tests 3 to 9 carried out at 60° C. and at 80° C. are examples not in accordance with the invention.

Results:

The characteristics of the copolymers are shown in Table 2.

Among the copolymers not in accordance with the invention (tests 3 to 9), the copolymers of tests 3, 4 and 9 have very low cold-flow values and therefore have a very low propensity to flow over time under their own weight. However, this result is obtained for high Mooney viscosity values, in particular above 80. In point of fact, it is known that the use of a polymer with too high a Mooney viscosity in a rubber composition can make the rubber composition difficult to extrude, and also can require high mixing energies for the incorporation of ingredients into the polymer.

Tests 5 to 8 show that it is possible to obtain copolymers of lower Mooney viscosity, but this means a higher catalytic cost and unfavourable properties for storage. Indeed, tests 3 to 9 show that the synthesis of copolymers of lower Mooney viscosity requires the use of a greater amount of cocatalyst and is inevitably accompanied by an increase in the cold-flow values.

The copolymers according to the invention (tests 1 and 2) do not exhibit the drawbacks mentioned. For the same targeted Mooney viscosity value as that of their counterparts synthesized at lower temperatures (tests 3 to 9), they are obtained with a much lower amount of cocatalyst and have a much lower cold-flow value. Consequently, the copolymers according to the invention have an improved compromise between their ability to be processed and their propensity to flow while making it possible to reduce the catalytic cost of their synthesis. The copolymers according to the invention have the particularity of being branched, whereas the copolymers of tests 3 to 9 are linear polymers, as demonstrated by the inherent viscosity values of the copolymers.

TABLE 1

| | Metallocene | Cocatalyst | P | T° | Conversion | Activity |
|---|---|---|---|---|---|---|
| Test | (mmol) | (mmol) | (bar) | (° C.) | (%) | (kg/mol · h) |
| 1 | 5.62 | 25.00 | 8.5 | 105 | 91.8 | 518 |
| 2 | 5.66 | 16.06 | 6.3 | 105 | 90.8 | 570 |
| 3 | 5.66 | 24.10 | 8.4 | 80 | 93.2 | 445 |
| 4 | 5.66 | 25.10 | 8.6 | 80 | 91.7 | 480 |
| 5 | 5.66 | 27.10 | 8.7 | 80 | 91.9 | 441 |
| 6 | 5.66 | 29.08 | 8.5 | 80 | 90.9 | 432 |
| 7 | 5.66 | 32.06 | 8.6 | 80 | 92.8 | 459 |
| 8 | 5.66 | 34.60 | 8.6 | 80 | 92.6 | 444 |
| 9 | 5.66 | 25.10 | 8.5 | 60 | 87.2 | 245 |

TABLE 2

| | | 1,2-cyclo- | | | | Crystal- |
|---|---|---|---|---|---|---|
| | Ethylene | hexanediyl | ML(1 + 4) | ηlnh | CF(1 + 6) | linity |
| Test | (mol %) | (mol %) | 100° C. | (dl/g) | 100° C. | (%) |
| 1 | 78.3 | 10.0 | 33 | 1.0730 | 13.99 | 3.0 |
| 2 | 78.8 | 9.8 | 77.9 | 1.3945 | 1.00 | 4.5 |
| 3 | 76.7 | 7.6 | 101.7 | 1.6286 | 2.29 | 3.9 |
| 4 | 76.8 | 7.5 | 85 | 1.5658 | 3.29 | 3.3 |
| 5 | 76.7 | 7.5 | 67 | 1.4543 | 6.83 | 4.0 |
| 6 | 76.9 | 7.7 | 52.3 | 1.3787 | 9.07 | 3.9 |
| 7 | 76.7 | 7.5 | 43.5 | 1.2905 | 12.79 | 3.5 |
| 8 | 76.9 | 7.7 | 36.3 | 1.3637 | 17.23 | 2.6 |
| 9 | 75.0 | 2.7 | 121.9 | 1.8303 | 1.95 | 2.9 |

1. A copolymer of ethylene and of a 1,3-diene containing more than 50 mol % of ethylene units and containing 1,2-cyclohexanediyl moieties, the 1,3-diene being 1,3-butadiene or a mixture of 1,3-dienes containing 1,3-butadiene, which copolymer consists of a main chain and of one or more side chains.

2. The copolymer as claimed in claim 1, in which at least one side chain is attached to the main chain by a covalent bond between a side chain carbon atom and a main chain carbon atom.

3. The copolymer as claimed in claim 2, in which the carbon atoms involved in the covalent bond to ensure attachment of the side chain to the main chain are carbon atoms resulting from the insertion of ethylene or of 1,3-diene into the copolymer by copolymerization.

4. The copolymer according to claim 1, in which the 1,3-diene is 1,3-butadiene.

5. The copolymer according to claim 4, which copolymer contains at most 15 mol % of 1,2-cyclohexanediyl moieties.

6. The copolymer according to claim 1, which copolymer contains more than 60 mol % of ethylene units.

7. The copolymer according to claim 1, which copolymer contains less than 90 mol % of ethylene unit.

8. The copolymer according to claim 1, which copolymer contains at most 85 mol % of ethylene units.

9. The copolymer according to claim 1, which copolymer is a statistical copolymer.

10. The copolymer according to claim 1, which copolymer is an elastomer.

11. The copolymer according to claim 1, having a degree of crystallinity of less than 20%.

12. The copolymer according to claim 1, having a degree of crystallinity of less than 10%.

13. The copolymer according to claim 1, having a degree of crystallinity of less than 5%.

14. A rubber composition which comprises a copolymer defined in claim 1.

15. A tire which comprises a rubber composition according to claim 14.
